(19) United States
(12) Patent Application Publication
(10) Pub. No.: US 2016/0136032 A1
(43) Pub. Date: May 19, 2016

(54) THERAPEUTIC MASSAGE DEVICE

(71) Applicant: Tara Dakides, Carbondale, CO (US)

(72) Inventor: Tara Dakides, Carbondale, CO (US)

(21) Appl. No.: 14/941,343

(22) Filed: Nov. 13, 2015

Related U.S. Application Data
(60) Provisional application No. 62/080,169, filed on Nov. 14, 2014.

(51) Int. Cl. A61H 15/00

(52) U.S. Cl. CPC A61H 15/0092; A61H 2015/005

(57) ABSTRACT

A travel-friendly, configurable therapeutic device or system that may be used for therapeutic treatments and massage is described. Multiple adjustments may allow the therapeutic device to work on many body types, shapes, and sizes. The therapeutic device may help treat and/or provide relief from kinks, body pain, and/or tension. The configurable therapeutic device may include a variety of components that may be assembled in different ways. The components may include trunk members removably attachable to each other and therapeutic objects that are removably attachable to the trunk members. The trunk members may include branches or branch members extending therefrom. The components may be used separately, assembled into small groups of components, or assembled all together for different uses or treatments.

### PRIORITY

This application claims the benefit of priority to U.S. Provisional Application No. 62/080,169, filed Nov. 14, 2014, which is incorporated by reference in its entirety into this application.

### BACKGROUND

Many people suffer from a variety of maladies, including body pains, injuries, stress, inflammation, digestion problems, buildup of toxins or blockages, circulation issues, knots in muscles, tense muscles, and/or other issues that may be beneficially treated using massage techniques. However, may people cannot afford professional therapeutic massages, cannot afford them as often as needed, or are otherwise unable or unwilling to receive a professional therapeutic massage treatment. Further, people may need different types of treatment and/or massage at different times or on different parts of their bodies. Many devices used for personal massage are limited, can only be used in very limited techniques, cannot be effectively used with certain body types or in certain areas of the body, and/or cannot otherwise satisfy many therapeutic requirements of users. Accordingly, there is a need for a do-it-yourself or personal therapeutic device or system that is more versatile and that will allow individual users to customize the therapeutic device/system to different needs and allow them to apply treatment and/or massage techniques to their own bodies in a variety of ways to meet a variety of needs. Athletes, physical therapy providers/patients, chiropractors and patients, mothers, people practicing or participating in yoga, Pilates, TRX, Kettle Bells and many other program based exercise classes, health conscious people looking to improve their overall health and wellness, and others may benefit significantly from such a versatile therapeutic device/system.

Disclosed herein are new devices, components, assemblies, systems, and methods for therapeutic treatment and/or massage, which avoid disadvantages currently experienced and help satisfy the goals, such as those described above. The concepts described herein may be applied to a wide variety of treatments, therapies, and uses.

### SUMMARY OF THE INVENTION

Embodiments of, and enhancements for, devices, components, assemblies, systems, methods, etc. for therapeutic treatment or therapy, including therapeutic massage, are described herein.

A travel-friendly, therapeutic system or configurable therapeutic device, which may be used for therapeutic massage, may focus on the core of the human body (“core” meaning the torso area, stomach, back, and internals) and/or the entire body for health or comfort purposes. Multiple adjustments may allow the therapeutic device to work on many body types, shapes, and sizes. The therapeutic device may help treat and/or provide relief from kinks, body pain, and/or tension from exercise, sports, injury, surgery, pregnancy, arthritis, tension in the jaw line and face, stress and emotions. Through applying pressure to a body (e.g., to muscles or other internals through the skin) with the therapeutic device and moving (e.g., sliding, rotating, winding, unwinding, walking, etc.) the therapeutic device over portions of the body (e.g., in sequenced movements), the therapeutic device may improve flexibility, pliability, general health, and/or general comfort in muscles, ligaments, soft tissue, internal organs and/or the intestinal tract. The therapeutic device may aid in releasing knots and tension that can block circulation in the body, and may be used to help improve circulation and relaxation throughout the body. The therapeutic device may also aid in treating and/or breaking down the following: blockages in the body, built up scar tissue, soft cartilage, bunions, calcium build up or deposits, and/or inflammation pockets. The therapeutic device may be used to help lengthen and create space in the joints (e.g., this may be done using a movement parallel to the body/limb across the joint), which can help relieve joint pain. The therapeutic device may aid in reducing inflammation through improving circulation/blood flow, lengthening and creating space for movement (e.g., in the joints), and helping to remove toxins.

When applying the therapeutic device to the core of the body with various movements (e.g., applying pressure to a region of the bowels and rotating/winding/unwinding the therapeutic device), it is believed that users can help themselves with the flushing of toxins within some of the body's major internal systems, including the digestive tract and the colon. Use of the therapeutic device in the abdominal area or region of the bowels may help improve digestion. Gas reactions and the need to have a bowel movement may occur very soon after using the therapeutic device in the abdominal region. Massaging and/or treating internals by using the therapeutic device in the abdominal region may also help target and relieve lower and mid-back pain. A user may use the therapeutic device on his/her body as a tool for everyday or periodic therapeutic treatments to help relieve stress and pain, and to aid in better health and relaxation.

In one embodiment, a therapeutic device/system (e.g., a therapeutic massage device) may be provided (e.g., obtained, retrieved, accessed for use, assembled, etc.) that includes features of any of the therapeutic device embodiments/variations described herein, and may be used in any of the ways/steps describe herein. For example, the therapeutic device may comprise a first trunk member including a first branch member extending perpendicularly from a main trunk portion of the first trunk member. The therapeutic device may also include a second trunk member (e.g., trunk member 40 or curved trunk member 46 described below) removably attachable to the first trunk member to form a combined elongate trunk having a first trunk end and an opposite second trunk end. The therapeutic device may also include one or more therapy objects removably attachable to the first trunk end, the second trunk end, and the first branch member. Optionally, the second trunk member may be curved such that the second trunk end extends in substantially the same direction as the first trunk end. The second trunk member may be sized and shaped such that the user may hold the first trunk end in front of the user's body and have the second trunk end extend behind the user's body for use in massaging a back of the user's body. Optionally, the second trunk member may be straight such that the second trunk end extends in an opposite direction from the first trunk end, and the second trunk member may include a second branch member extending perpendicularly from a main trunk portion of the second trunk member.

A protrusion may be formed on an end of the first trunk member and a receptacle configured to mate with the protrusion is formed on an end of the second trunk member, and wherein the second trunk member is removably attachable to the first trunk member by inserting the protrusion into the receptacle. A connector nut may be configured to hold the protrusion and the receptacle in a securely attached configuration. The connector nut may include features (e.g., locking receptors) that interact with features (e.g., locking extensions) on or adjacent to the protrusion and the receptacle to hold the protrusion and the receptacle in the securely attached configuration. The protrusion of the first trunk member may include a non-circular cross-sectional shape, and the receptacle of the second trunk member may include a corresponding non-circular cross-sectional shape.

The protrusion and the receptacle may be configured such that the protrusion may be inserted into the receptacle in a first position and a second position, wherein the first trunk member is positioned at a first angle relative to the second trunk member when the protrusion is in the first position and the first trunk member is positioned at a second angle relative to the second trunk member when the protrusion is in the second position, the second angle being different from the first angle. The protrusion may include a four-sided cross-sectional shape (e.g., square, roughly square, rectangle, roughly rectangle, etc.), and the receptacle may include a corresponding four-sided cross-sectional shape (e.g., square, roughly square, rectangle, roughly rectangle, etc.). The protrusion and the receptacle may be configured such that the protrusion may be inserted into the receptacle in a first position, a second position, a third position, and a fourth position, wherein the first trunk member is positioned at a first angle relative to the second trunk member when the protrusion is in the first position, the first trunk member is positioned at a second angle relative to the second trunk member when the protrusion is in the second position, the first trunk member is positioned at a third angle relative to the second trunk member when the protrusion is in the third position, and the first trunk member is positioned at a fourth angle relative to the second trunk member when the protrusion is in the fourth position, and wherein the second angle is offset 90° from the first angle, the third angle is offset 90° from the second angle, and the fourth angle is offset 90° from the third angle. Each side of the protrusion may be equal in size (e.g., as in a square or roughly square shape), and each side of the receptacle may be correspondingly equal in size (e.g., as in a square or roughly square shape).

The one or more therapy objects may include more than one therapy objects, and the more than one therapy objects may be configured as balls of at least two different sizes. The more than one therapy objects may include ridges forming an outer surface of the more than one therapy objects, the ridges including deep valleys therebetween. The one or more therapy objects include more than one therapy object, and the more than one therapy objects may be configured as balls of at least four different sizes. The therapeutic device may also include one or more spinners that may be arranged on a portion of the elongate trunk, including on the main trunk portion of the first trunk member or the main trunk portion of the second trunk member, such that the one or more spinners may freely spin. The therapeutic device may also include one or more caps that may be used to close one or more openings of the one or more therapy objects. For example, a first cap of the one or more caps may be used to close an opening of a first therapy object of the one or more therapy objects, wherein the first therapy object is configured as a ball, and wherein when the first cap closes the opening of the first therapy object, the combined first cap and first therapy object form a closed ball or sphere.

The therapeutic device may further comprise a connector configured to join a first therapy object and a second therapy object together to form a combined therapy object in which there is little, very little, or no space between the first therapy object and the second therapy object. The connector may be configured such that the combined therapy object may be adjusted and locked into a first position in which the first therapy object and the second therapy object are separated by a first distance and into a second position in which the first therapy object and the second therapy object are separated by a second distance different from the first distance.

The therapeutic device may further comprise a connector, wherein a first bore configured to mate with a first end of the connector is formed at an end of the first trunk member and a second bore configured to mate with a second end of the connector is formed at an end of the second trunk member, and wherein the connector can be used to connect/attach the second trunk member to the first trunk member to form the combined elongate trunk. The first bore may mate with the first end of the connector and the second bore may mate with the second end of the connector to connect/attach the second trunk member to the first trunk member. The first bore and the second bore may be similarly shaped and configured and the first end and second end of the connector may be similarly shaped and configured. The connector may also mate with a bore of a therapy object and may be used to connect the therapy object to the end of the first trunk member or to the end of the second trunk member.

The therapeutic device may further comprise a bore or hole formed in a first therapy object of the one or more therapy objects, and may further comprise one or more than one therapy enhancement elements configured to be removably received within the bore or hole. The one or more therapy enhancement elements may be selected from the group consisting of a heating element, a vibrational element, an electrical element (e.g., a micro current element), a laser therapy element, and/or an LED therapy element. A portion of the elongate trunk and/or main trunk portion of the first trunk member may be hollow, whereby the one or more therapy enhancement elements may be selectively stored within the portion of the elongate trunk and/or the main trunk portion of the first trunk member. A cap may be selectively positionable within the bore of the first therapy object to retain the therapy enhancement element therein.

In one embodiment, a therapeutic device/system (e.g., a therapeutic massage device) may be provided (e.g., obtained, retrieved, accessed for use, assembled, etc.) that includes features of any of the therapeutic device embodiments/variations described herein, and may be used in any of the ways/steps describe herein. For example, the therapeutic device may comprise one or more therapy objects and a connector that may be used to connect two of the one or more therapy objects together (e.g., to form a combined therapy object in which there is little, very little, or no space between a first therapy object and a second therapy object). The therapeutic device may also include one or more caps that may be used to close off bores of the one or more therapy objects to form one or more closed therapy objects (e.g., closed balls) for individual use. For example, the therapeutic device may include a first therapy object including a first bore in a portion of the first therapy object and a second therapy object including a second bore in a portion of the second therapy object. The therapeutic device may include a connector having a first connection end and a second connection end, wherein the first connection end is designed to mate with the first bore of the first therapy object and the second connection end is designed to mate with the second bore of the second therapy object such that the first therapy object and the second therapy object can be connected together using the connector to form a combined therapy object in which there is little, very little, or no space between the first and second therapy objects. The connector may be configured or designed such that the combined therapy object may be adjusted and locked into a first position in which the first therapy object and the second therapy object are separated by a first distance and into a second position in which the first therapy object and the second therapy object are separated by a second distance different from the first distance.

The therapeutic device may also include a third therapy object including a third bore and a fourth therapy object including a fourth bore, wherein the first connector end and the second connector end are designed to mate with each of the first bore, second bore, third bore, and fourth bore such that various combination of the first therapy object, the second therapy object, the third therapy object, and the fourth therapy object may be interchangeably connected to the first connector end and the second connector end to form various configurations of the combined therapy object. The therapeutic device may include one or more caps that may be used to close one or more of the first bore, the second bore, the third bore, and the fourth bore to form one or more closed balls that may be used individually for massage from a combination of the one or more caps and one or more of the first therapy object, the second therapy object, the third therapy object, and the fourth therapy object.

In one embodiment, the therapeutic device may include 2, 3, 4, 6, 7, 8, 9, or 10 therapy objects of various sizes and shapes. For example, a therapeutic device may include two therapy objects of a first size and two therapy objects of a second size different from the first size). The therapeutic device may also include a connector to connect two or more of the therapy objects together (e.g., such that there is little, very little, or no space between the therapy objects). The connector may include one or more ends that mate with one or more bores of the therapy objects. The therapeutic device may also include one or more caps that may be used to close the one or more bores of the therapy objects (e.g., if there are four therapy objects, there may be four caps, etc.) One or more sleeves or covers (e.g., a neoprene sleeve) may be used to cover the therapeutic device or one or more of its components, e.g., to cover the therapy objects, to provide a softer surface or some cushioning between the device and the person's body. Other features of the therapeutic device embodiments/variations described herein may also be included.

In one embodiment, a method of treatment, massage, and/or therapy may include any of the steps and/or uses described herein, and may involve use of a therapeutic device/system (e.g., a therapeutic massage device) that includes features of any of the therapeutic device embodiments/variations described herein. For example, a method of massage treatment may comprise obtaining a configurable therapeutic device having a first trunk member (e.g., one of trunk members 30, 40, 46), a second trunk member (e.g., one of trunk members 30, 40, 46), and more than one therapy objects (e.g., any of the various therapy objects described herein) removably attachable to the first trunk member and the second trunk member. The method may also include assembling the configurable therapeutic device in a first configuration in which the first trunk member is attached to the second trunk member to form an elongate trunk, a first therapy object of the more than one therapy objects is attached to the first trunk member and a second therapy object of the more than one therapy objects is attached to the second trunk member (however, many other configurations are possible and may involve additional components or features described herein). The method may also include applying pressure to a first region of a body with the configurable therapeutic device using at least one of the first therapy object and the second therapy object, and/or moving the configurable therapeutic device in the first region of the body while applying continuous pressure. The method may also comprise moving the configurable therapeutic device to a second region of the body from the first region of the body while continuing to apply pressure.

The method may also include disassembling the configurable therapeutic device from the first configuration and/or reassembling the configurable therapeutic device in a second configuration different from the first configuration. In one embodiment, the second configuration may include the second trunk member being offset or rotated to an angle (e.g. 90° offset) different from the second trunk members position in the first configuration (e.g., relative to the first trunk member). In one embodiment, the second configuration may include therapy objects of different sizes arranged at different points on the therapeutic device. Reassembling may include rearranging relative positions of therapy objects on the therapeutic device. The first trunk member and/or the second trunk member may include one or more branch members onto which therapy objects of various sizes may be attached and arranged in different configurations. Some components of the configurable therapeutic device may be used in one configuration but not in another configuration, and multiple different sub-devices (e.g., devices using only some of the components) may be assembled using the various components. In one embodiment, a sub-device may include at least two therapy objects (e.g., therapy objects configured as balls) connected together with a connector configured to allow the therapy objects to be attached with little, very little, and/or no space between the therapy objects.

The configurable therapeutic device may include a third trunk member, the third trunk member may include a curved portion, and reassembling the configurable therapeutic device in a second configuration different from the first configuration may include attaching the first trunk member to the third trunk member to form an elongate trunk with a curved portion. One or more of the components of the configurable therapeutic device used in the first configuration may be omitted or not used in the second configuration (e.g., second trunk member might not be used in the second configuration). The method may also comprise disassembling and/or reassembling the second configuration to form a third configuration different from the first configuration and the second configuration. In one embodiment, the third configuration may include the third trunk member being offset 90° from its position in the second configuration (e.g., relative to the first trunk member). One or more of the components of the configurable therapeutic device used in the second configuration may be omitted or not used in the third configuration, and so on.

The method may also include inserting or placing one or more therapy enhancement elements inside one or more bores of one or more therapy objects. The one or more therapy enhancement elements may include, for example, a heating element, a vibrational element, an electrical element (e.g., a micro current element), a laser therapy element, and/or an LED therapy element. The method may also include attaching the one or more therapy objects having one or more therapy enhancement elements therein to one or more trunk members and/or one or more branch member of the trunk members. The therapy enhancement elements may be used with the therapeutic device (e.g., inside the therapy objects) to further enhance treatment and/or massage. The method may also include inserting one or more therapy enhancement elements inside a first therapy object and closing the therapy object with a cap or plug to for a closed sphere or ball containing the therapy enhancement element therein. The one or more therapy enhancement elements may be used inside the one or more therapy object while activated to produce the therapy enhancement effect.

### BRIEF DESCRIPTION OF THE DRAWINGS

The disclosed devices, components, assemblies, systems and methods can be better understood with reference to the description taken in conjunction with the following drawings, in which like reference numerals identify like elements. The components in the drawings are not necessarily to scale.

FIG. 1 shows an exploded view of an exemplary therapeutic device;

FIG. 2 shows components of an exemplary therapeutic device arranged in a first exemplary combination;

FIG. 3 shows components of an exemplary therapeutic device arranged in a second exemplary combination different from the first exemplary combination of FIG. 2;

FIG. 4A shows an isometric view of a first exemplary trunk member of FIG. 1;

FIG. 4B shows a close up end view of the protrusion of the first exemplary trunk member of FIG. 1;

FIG. 5 shows an isometric view of a second exemplary trunk member of FIG. 1;

FIG. 6 shows an isometric view of an exemplary curved trunk member of FIG. 1.

FIG. 7 shows a close up end view of a receptacle of an exemplary trunk member as may be found, for example, on the second exemplary trunk member and/or the curved exemplary trunk member of FIG. 1;

FIG. 8 shows an exemplary connector nut that may be used to help hold two trunk members together;

FIG. 9 shows exemplary therapy objects configured as spinners and open-ended mid-sized balls arranged in an exemplary combination on a portion of a trunk member;

FIG. 10 shows exemplary therapy objects configured as spinners arranged on a portion of a trunk member;

FIG. 11 shows an isometric view of an exemplary therapy object configured as a spinner;

FIG. 12 shows an end view of the exemplary therapy object configured as an spinner of FIG. 11;

FIG. 13 shows an isometric view of an exemplary therapy object configured as an open-ended mid-sized ball;

FIG. 14 shows an end view of the exemplary therapy object configured as an open-ended mid-sized ball of FIG. 13;

FIG. 15 shows an isometric top, side view of an exemplary therapy object configured as a ball;

FIG. 16 shows an isometric bottom, side view of the exemplary therapy object configured as a ball of FIG. 15;

FIG. 17 shows an exemplary plug or cap that may be used to close an opening or bore of a therapy object;

FIG. 18 shows a transparent view of an exemplary therapy object closed by an exemplary plug or cap;

FIG. 19 shows an exemplary plug or cap with a female Allen wrench shaped receptacle that may be used to close an opening or bore of a therapy object

FIG. 20 shows an exemplary male Allen wrench shaped protrusion extending out from a surface of an end of a trunk member or branch member shaped to mate with a female Allen wrench receptacle, e.g., the female Allen wrench receptacle of FIG. 19.

FIG. 21 shows an exemplary connector that may be used to connect therapy objects; and

FIG. 22 shows a transparent view of two therapy objects configured as balls that are connected to opposite sides of a connector.

FIG. 23 shows an exemplary therapeutic device;

FIG. 24 shows an exploded view of the exemplary therapeutic device of FIG. 23;

FIG. 25 shows a cross sectional view of an exemplary therapy object along 25-25 shown in FIG. 24;

FIG. 26 shows an exemplary therapeutic device arranged in a first exemplary configuration including a curved trunk member aligned along the same plane as branch members of a first trunk member;

FIG. 27 shows the exemplary therapeutic device of FIG. 26 in a second exemplary configuration with the curved trunk member rotated 90° from the first exemplary configuration shown in FIG. 26 and aligned along a plane perpendicular to a plane along which the branch members of the first trunk member are aligned;

FIG. 28 shows an end view of the exemplary therapeutic device of FIG. 26 in the first exemplary configuration and shows, in outline, an end view of the position of the curved trunk member when in the second exemplary configuration of FIG. 27;

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Described herein are devices, components, assemblies, systems, methods, etc. for therapeutic treatment or therapy, including therapeutic massage. The description and accompanying figures, which describe and show certain embodiments, are made to demonstrate, in a non-limiting manner, several possible configurations of therapeutic devices, components, assemblies, systems, etc. and various methods of using them according to various aspects and features of the present disclosure. Accordingly, the disclosure is not limited to the specific embodiments described. Rather, the inventive principles associated with the embodiments described herein, including with respect to the therapeutic devices, components, assemblies, systems, methods, etc. described herein, may be applied in a variety of ways, including to other types of devices, components, assemblies, systems, methods, etc. General devices, components, assemblies, systems, methods, etc. are described herein sufficiently to enable one to develop a variety of implementations/applications without undue experimentation. In the development of particular applications, numerous implementation-specific decisions will be made to achieve the design-specific goals, which will vary from one implementation/application to another. It will be appreciated that such a development effort would be a routine undertaking for persons of ordinary skill in the art having the benefit of this disclosure.

This document does not intend to distinguish between components that differ in name but not function. In the following discussion and in the claims, the terms “including,” “includes,” “comprising,” “have,” and “has” are used in an open-ended fashion, and thus should be interpreted to mean “including, but not limited to.” The word “or” is used in the inclusive sense (i.e., “and/or”) unless a specific use to the contrary is explicitly stated.

Therapeutic devices/systems for massage described herein may focus on the core of the human body (“core,” as used herein, refers to the torso area, stomach, back and internals) and the entire body for overall health. Treatment of a person's core with the therapeutic device may have a significant impact on health and comfort. The therapeutic massage device may be constructed and designed in a travel friendly way (e.g., the therapeutic massage device may be collapsible, or may be easily disassembled into smaller component parts, may include an travel bag or package to hold the therapeutic massage device, etc.) The therapeutic massage device may include multiple adjustments allowing the device to work on many different body shapes and sizes and be used in many different ways. The therapeutic massage device may be used to help improve overall health and wellness of users of the device. For example, the therapeutic massage device may help work out the kinks, body pain, and/or tension from exercise, sports, injury, surgery, pregnancy, arthritis, tension in the jaw line and face, stress and emotions. The therapeutic massage device may be used by health conscious people (including, for example, athletes) and may be used for Physical Therapy, Chiropractic treatment, Yoga, Pilates, TRX, Kettle Bells and many other program-based exercise classes.

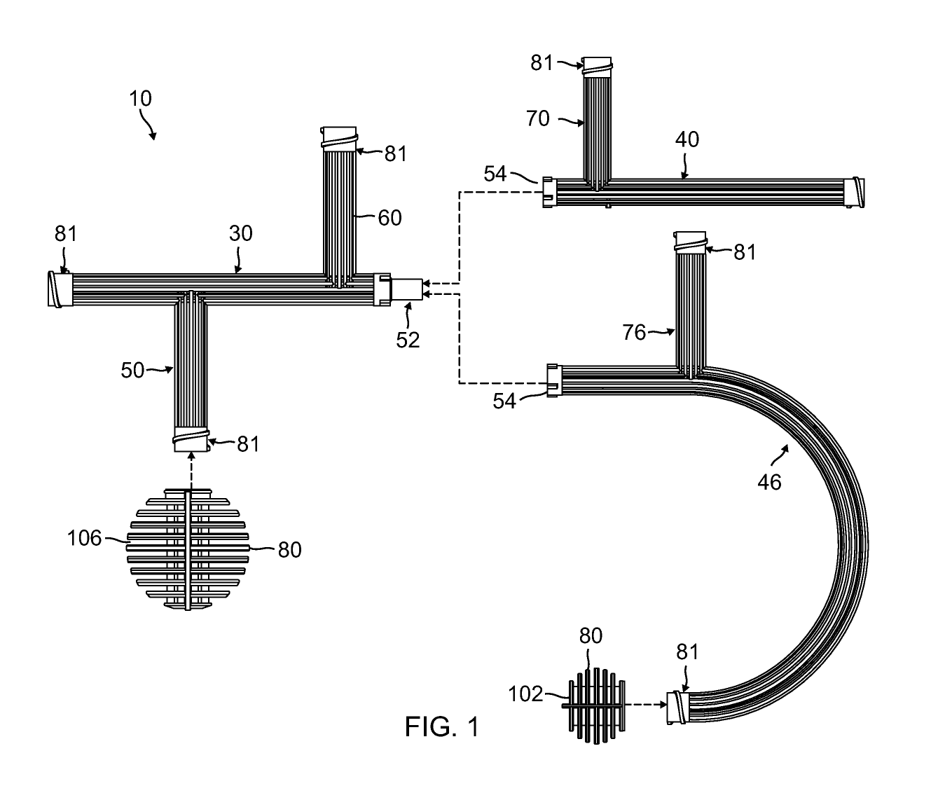

FIG. 1 shows an exploded view of an exemplary therapeutic device/system 10. Therapeutic device/system 10 may be used as a therapeutic massage device for personal massage (e.g., massaging a user's own body) or for massaging or treating another person (e.g., massaging a patient's body).

Through applying pressure to a body (e.g., to muscles or other internals through the skin) with the therapeutic device 10 and moving (e.g., sliding, rotating, winding, unwinding, walking, etc.) the therapeutic device 10 over portions of the body (e.g., in sequenced movements), the therapeutic device 10 may improve flexibility, pliability, general health, and/or general comfort in muscles, ligaments, soft tissue, internal organs and/or the intestinal tract. The therapeutic device 10 may aid in releasing knots and tension that can block circulation in the body, and may be used to help improve circulation and relaxation throughout the body. The therapeutic device 10 may also aid in treating and/or breaking down the following: blockages in the body, built up scar tissue, soft cartilage, bunions, calcium build up or deposits, and/or inflammation pockets. The therapeutic device 10 may be used to help lengthen and create space in the joints (e.g., this may be done using a movement parallel to the body/limb across the joint), which can help relieve joint pain. The therapeutic device 10 may aid in reducing inflammation through improving circulation/blood flow, lengthening and creating space for movement (e.g., in the joints), and helping to remove toxins.

When applying the therapeutic device 10 to the core of the body with various movements (e.g., applying pressure to a region of the bowels and rotating the therapeutic device 10), it is believed that users can help themselves with the flushing of toxins within some of the body's major internal systems, including the digestive tract and the colon. Use of the therapeutic device 10 in the abdominal area or region of the bowels may help improve digestion. Gas reactions and the need to have a bowel movement may occur very soon after using the therapeutic device 10 in the abdominal region. Massaging and/or treating internals by using the therapeutic device 10 in the abdominal region may also help target and relieve lower and mid-back pain. A user may use the therapeutic device 10 on his/her body as a tool for everyday or periodic therapeutic treatments to help relieve stress and pain, and to aid in better health and relaxation.

Therapeutic device/system 10 may include a variety of components or pieces that may be arranged or connected in a variety of ways for different treatment benefits. For example, therapeutic device 10 may include one or more trunk pieces or members (e.g., a first trunk member 30, a second trunk member 40, and a curved trunk member 46 as shown in FIG. 1) that may form an elongate trunk 20. The elongate trunk 20 may have a first trunk end 22 and an opposite second trunk end 24. The therapeutic device 10 may also include one or more therapy objects 80. In one embodiment, the therapeutic device 10 may have two, three, four, or five trunk members that may be combinable to form the main body of the therapeutic device 10. In one embodiment, the therapeutic device 10 may also include or be provided with any number between 2-30 (or any number between 6-25, or about 20) attachable and detachable therapy objects 80. The therapy objects 80 may be configured as balls, and may be provided in a variety of different sizes (e.g., small, medium, large and extra large) and shapes (e.g., a spherical ball, an ovoid shaped ball, a spheroid shaped ball, etc.). In one embodiment, 4, 5, 6, 7, 8, 9, or 10 therapy objects 80 configured as balls may be included or provided with the therapeutic device 10. In one embodiment, eight therapy objects 80 may be included or provided with the therapeutic device 10, and the eight therapy objects 80 configured as balls may be included/provided as two balls in each of four sizes (e.g., small, medium, large, and extra large).

In one embodiment, the therapeutic device/system 10 may also include or be provided with 4, 5, 6, 7, 8, 9, or 10 therapy objects 80 configured as attachable and detachable spinners 110 and/or open-ended mid-size balls 112. The attachable and detachable spinners 110 and/or open-ended mid-size balls 112 may be configured to slide onto a portion of the trunk of the therapeutic device 10 and/or one of the trunk members. In one embodiment, eight spinners 110 and/or two or four open-ended mid-size balls 112 may be included or provided with therapeutic device 10. In one embodiment, caps 88 may be provided that are configured to close an opening or a bore 84 in the therapy objects 80 (e.g., if threaded, the caps 88 may twist into the therapy objects 80). In one embodiment, the caps 88 may be used to complete the sphere of the therapy objects 80 (e.g., of therapy objects 80 configured as balls) and form closed balls, such closed balls may be used individually or together for treatment and/or massage. One or more sleeves or covers (e.g., a neoprene sleeve(s)) may be used to cover the therapeutic device or one or more of its components, e.g., to cover the therapy objects, to provide a softer surface or some cushioning between the device and the person's body.

In one embodiment, a connector 120 may be included or provided for connecting two or more therapy objects 80 together, e.g. a double-sided connector 120 may connect two therapy objects 80 (e.g., two balls 102, 104, 106, and/or other shaped balls) together side by side. The therapeutic device 10 may have a pattern of ridges on one or more of the components or throughout that help aid in the function and health benefits when in use. The ridges may be horizontal, vertical, and/or oblique. The ridges may include deep and/or shallow valleys between the ridges.

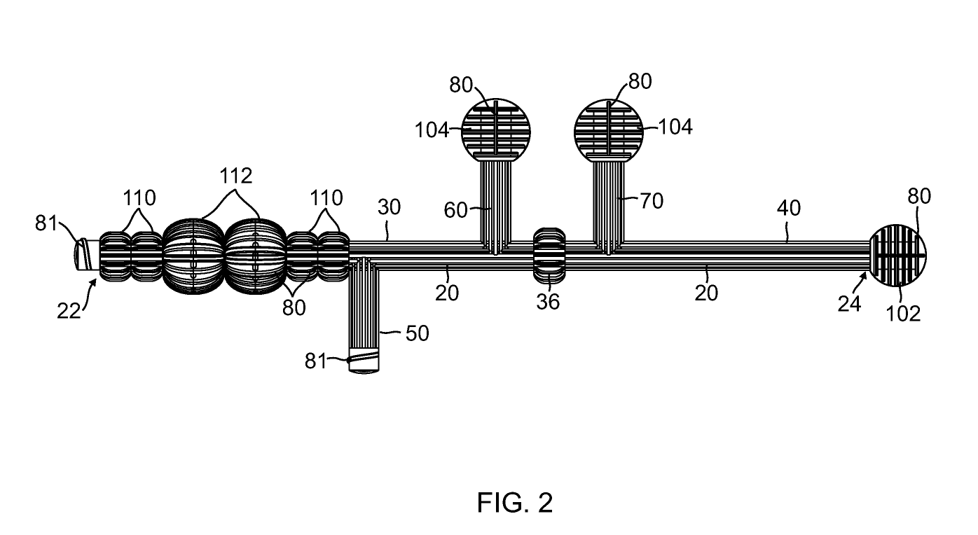

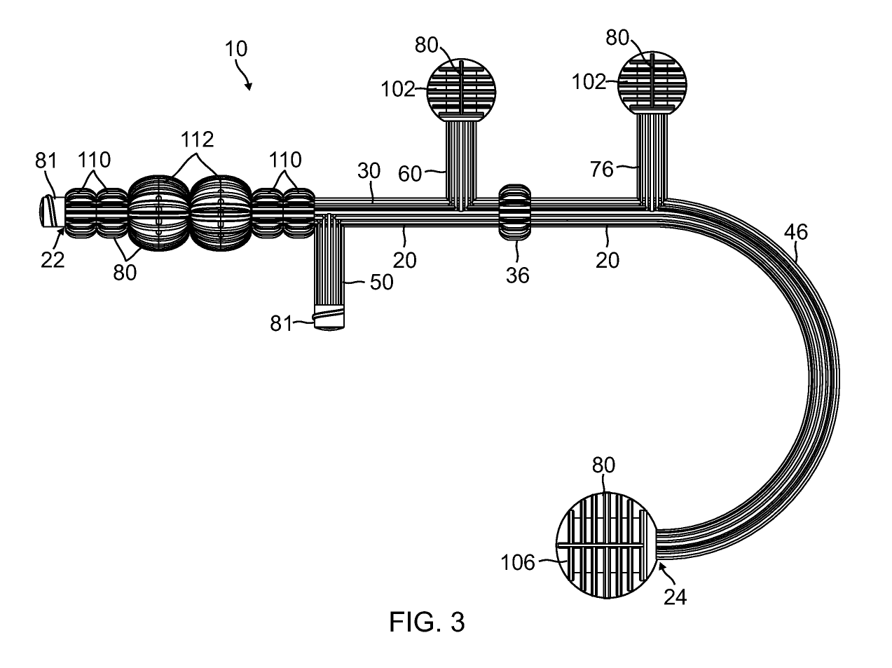

Various components or pieces of therapeutic device/system 10 (e.g., components discussed herein) may be arranged, rearranged, combined, etc. in a variety of ways, as desired, for different uses, treatments, and/or therapeutic effects. Some components or pieces might be used in one combination, but not used in other combinations. FIGS. 2 and 3 show components of therapeutic device 10 arranged in different exemplary combinations.

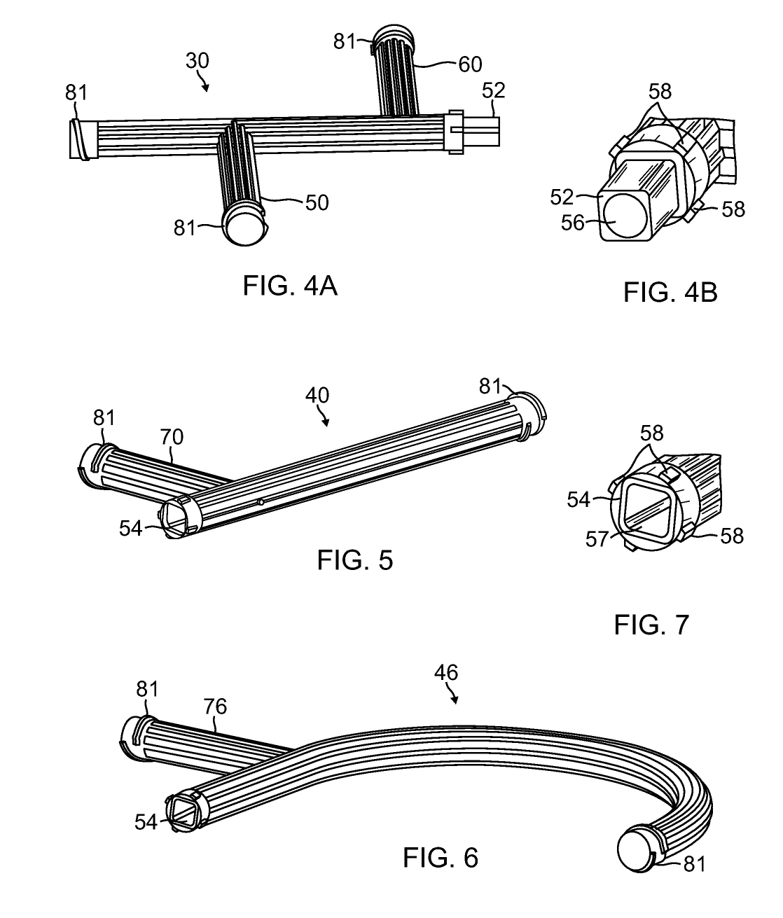

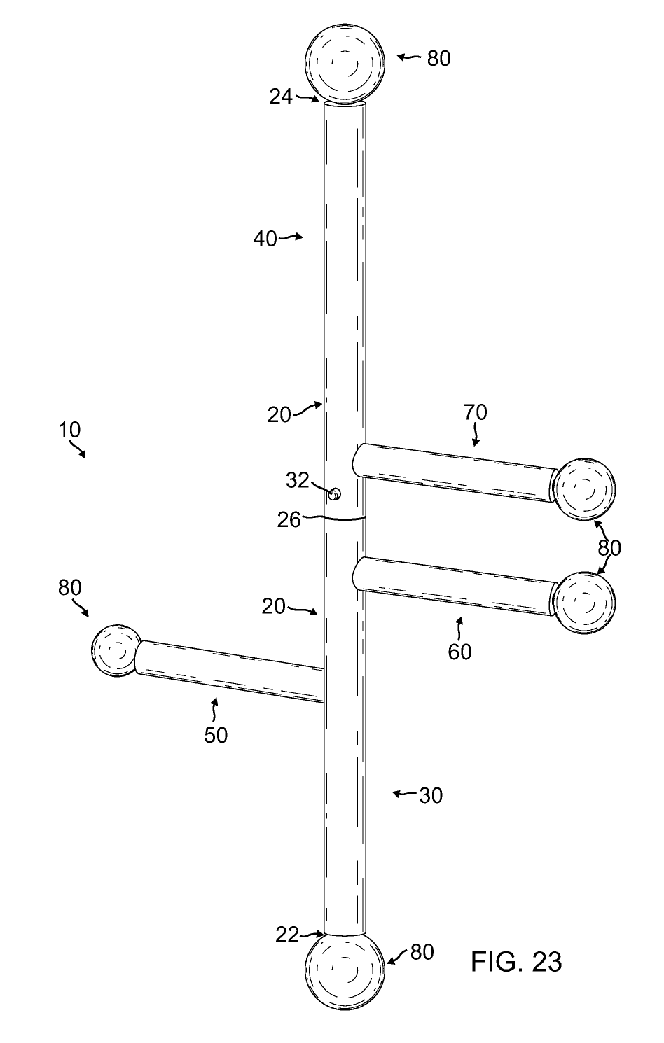

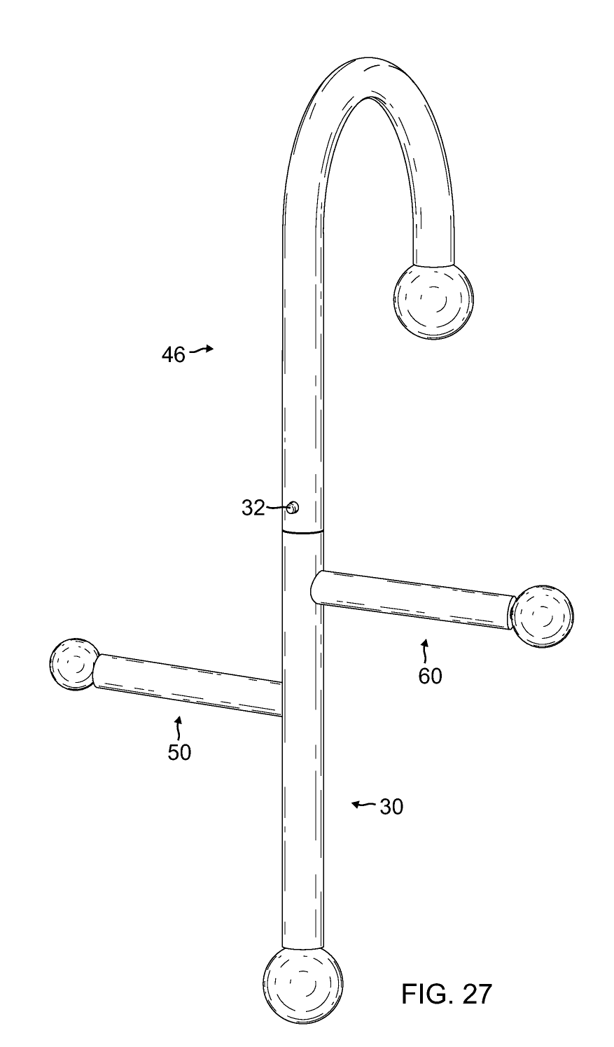

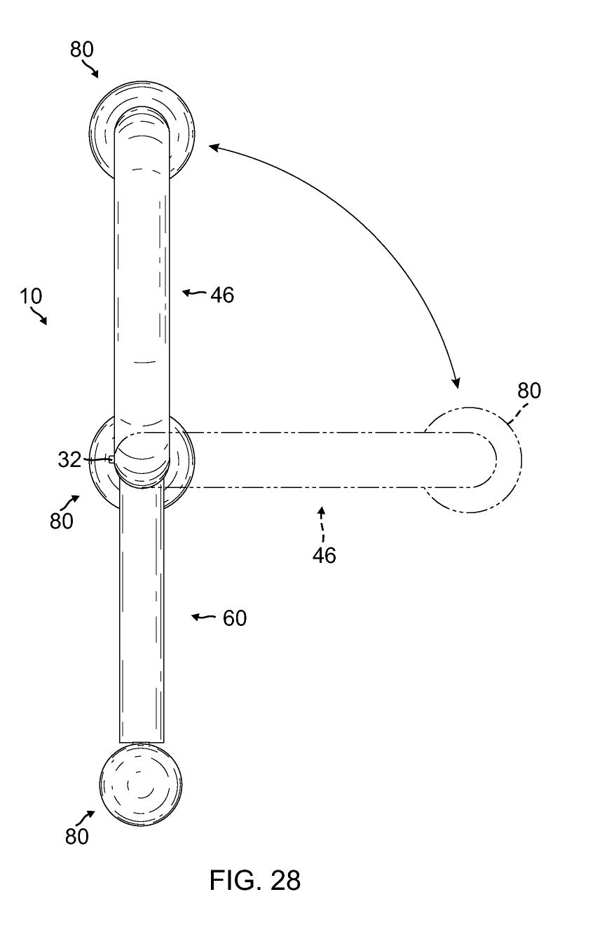

Two or more trunk members (e.g., a first trunk member 30, a second trunk member 40, and/or a third curved trunk member 46) may be combined to form the elongate trunk 20. Elongate trunk 20 may act as a structural backbone for the therapeutic device 10. FIG. 4A shows an isometric view of the trunk member 30 of FIG. 1. FIG. 5 shows an isometric view of the trunk member 40 of FIG. 1. While FIG. 6 shows an isometric view of the curved trunk member 46 of FIG. 1. Curved trunk member 46 may be curved in a variety of ways, e.g., curved trunk member 46 may be curved such that the second trunk end 24 extends in substantially the same direction as the first trunk end 22. The trunk members may be removably coupleable/attachable to each other. The trunk members may have a hollow interior, may be solid throughout, or may have a combination of hollow and solid portions. The trunk members may have ridges formed along an outside surface (e.g., as shown in FIGS. 1-7) or may have a smooth outer surface (e.g., as shown in FIGS. 23-28). The ridges may beneficially facilitate certain types of massage with the trunk members and improve gripping. Trunk members may be made of one or more of a variety of materials. In one embodiment, trunk members are made of a relatively hard, sturdy material, e.g., metal, aluminum, wood, and/or a hard plastic material or nylon.

The trunk members (e.g., trunk member 30, trunk member 40, and/or curved trunk member 46) may be of a variety of sizes and shapes, including those shown in the figures. In one embodiment, trunk member 30 may have a length along its main trunk portion (i.e., not including any branch members) in the range from about 5 inches to about 20 inches, or from about 7 inches to about 15 inches (e.g., a length of about 10 inches or about 11 inches). In one embodiment, trunk member 40 may have a length along its main trunk portion (i.e., not including any branch member) in the range from about 5 inches to about 20 inches, or from about 7 inches to about 15 inches (e.g., a length of about 10 inches or about 11 inches). In one embodiment, curved trunk member 46 may have a length from receptacle 54 to the plane extending along the furthest point of the curve in the range from about 7 inches to about 25 inches, or from about 10 inches to about 18 inches (e.g., a length of about 13 inches or about 14 inches). In one embodiment, curved trunk member 46 may have a radius of curvature in the range from about 3 inches to about 10 inches, or from about 4 inches to about 7 inches (e.g., a radius of about 5 inches, 5.5 inches, or about 6 inches). Each of the trunk members may have the same width or diameter or varied widths or diameters. In one embodiment, each of the trunk members has a generally circular cross section sized between about 0.25 inches to about 2 inches, or from about 0.75 inches to about 1.5 inches (e.g., about 1 inch). (The term “about” as used here encompasses variations within +0.5.)

Various ways of coupling/attaching the trunk members together are possible, e.g., a threaded or screw-like connection, friction fit, latches, clamps, mating connection, locking pin, a connector (e.g., connector 120), other attachments, and/or a combination of these. In one embodiment, trunk member 30 may include a key-like portion or protrusion 52 extending from an end of the trunk member 30. Trunk member 40 and/or curved trunk member 46 may include a keyhole-like portion or a receptacle 54 on an end thereof. The keyhole-like portion or a receptacle 54 may be configured to mate with or otherwise attach to key-like portion or protrusion 52 extending from an end of the trunk member 30. For example, protrusion 52 may fit inside of receptacle 54, e.g., in a snug fit or a close fit.

The protrusion 52 and receptacle 54 may be configured and shaped such that they fit together. Various shapes are possible for protrusion 52 and receptacle 54, e.g., square, circular, rectangular, triangular, pentagonal, hexagonal, three-sided, four-sided, five-sided, six-sided, etc. In one embodiment, protrusion 52 may have a roughly square (e.g., almost square, for example, square with rounded corners) or four-sided outer cross sectional shape as shown, for example, in FIG. 4B. Optionally, protrusion 52 may also have an opening 56 therein. Opening 56 may have a variety of shapes and sizes, e.g., opening 56 may have a square, circular, rectangular, triangular, pentagonal, hexagonal, etc. cross sectional shape. The shape of opening 56 may correspond to or be different from the outer shape of the protrusion 52, e.g., in FIG. 4B, the outer shape of protrusion 52 has a roughly square or four-sided shape, but opening 56 has a circular cross sectional shape. Optionally, opening 56 may open to and/or communicate with a hollow interior of the trunk member 30, e.g., such that therapy enhancement elements 86 may be placed and/or stored in an interior of the trunk member 30.

Receptacle 54 may have a shape that corresponds to the shape of the protrusion 52 or the outer portion of the protrusion 52. For example, the receptacle 54 may include an opening 57 that is shaped to receive the protrusion 52 therein, e.g., with a snug or close fit. In one embodiment, as shown in FIGS. 5-7, the opening 57 may have a roughly square or four-sided shaped cross section. FIG. 7 shows a close up view of a receptacle 54 as may be on an end of trunk member 40 or on an end of curved trunk member 46. Optionally, opening 57 may open to and/or communicate with a hollow interior of the trunk members 40 and/or 46, e.g., such that therapy enhancement elements 86 may be placed and/or stored in an interior of the trunk members.

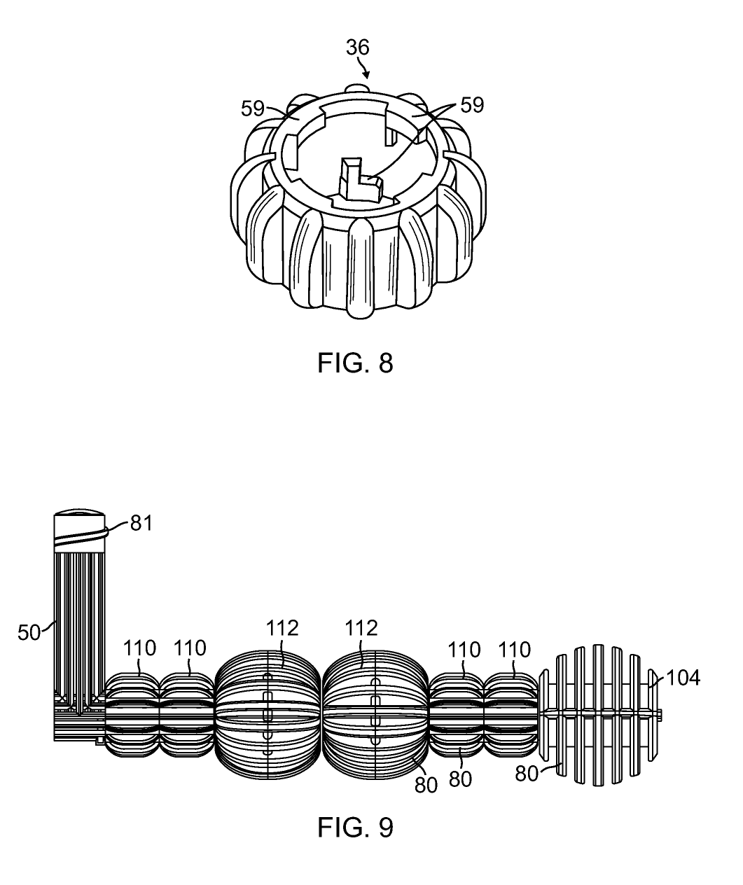

The protrusion 52 and receptacle 54 may include or be located adjacent to features 58 (e.g., locking extensions and/or a similar aid) to help lock the trunk members together. For example, when protrusion 52 is inserted into receptacle 54, the locking extensions 58 on or adjacent to the protrusion 52 and receptacle 54 may line up with and/or be near to each other. A connector nut 36 (or similar device or clamp) may be positioned over the joint between the trunk members such that it covers the joint and the locking extensions 58. FIG. 8 shows an exemplary connector nut 36. The connector nut 36 may include one or more features 59 (e.g., locking receptors and/or similar features). When the connector nut 36 is placed over the joint between the trunk members and the locking extensions 58, the connector nut 36 may be turned until the locking receptors 59 engage the locking extensions 58 such that the two trunk members are securely and tightly connected. When locked in this way, the elongated trunk 20 is secure and stable and may be used for a variety of purposes without causing separation between the trunk members. When a user desires the separate the trunk members again, the user may rotate the connector nut 36 until the locking receptors 59 disengage from the locking extensions 58 and allow separation of the trunk members. The connector nut may include ridges along an outer surface to allow a user to better grip and rotate the connector nut 36.

In one embodiment, as shown in FIG. 8, the locking receptors 59 may be roughly “L” shaped. The horizontal portion of the “L” shape (or the portion extending perpendicular to the longitudinal axis of the straight portion of the elongate trunk 20) may act to abut an end of the locking extensions 58 and prevent axial movement of the locking extensions 58 (and thereby prevent axial movement or separation of the trunk members). Whereas the vertical portion of the “L” shape (or the portion extending in the direction of the longitudinal axis of the straight portion of the elongate trunk 20) may act as a stop that contacts a side of a locking extension 58 to prevent further rotation of the connector nut 36 beyond the point where the horizontal portion abuts the ends of the locking extensions 58. Rotation of the connector nut 36 in the direction opposite the vertical portion of the “L” shape allows the locking extensions 58 to move past the horizontal portion of the “L” shape and slide free from each other.

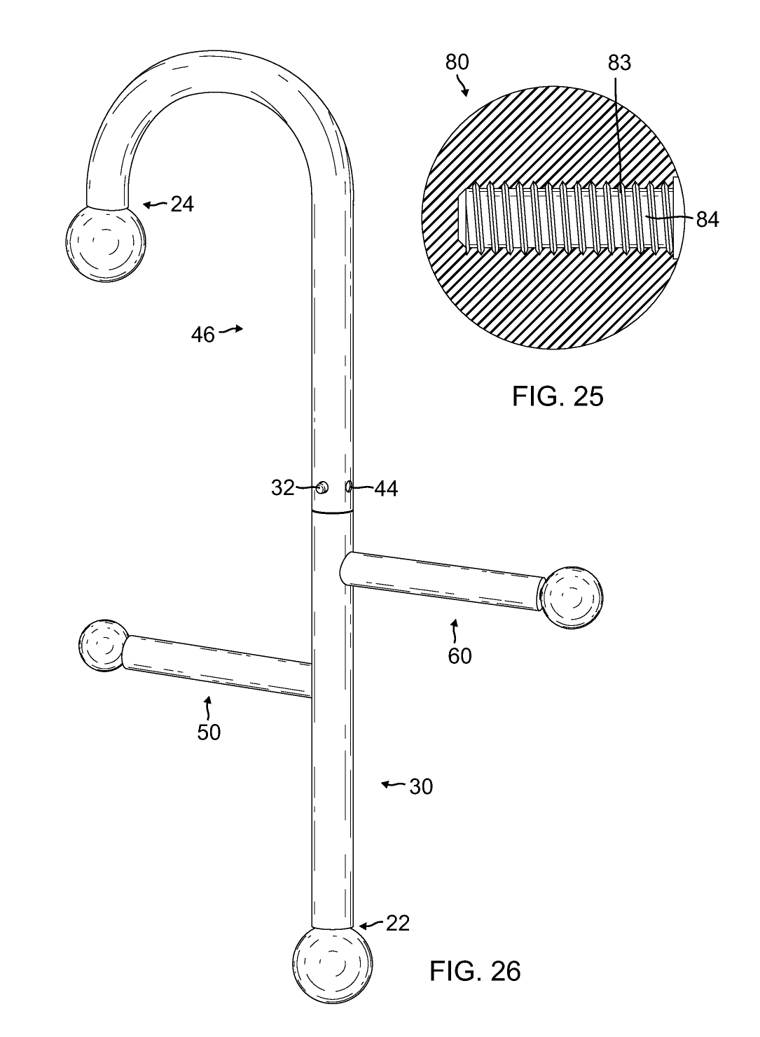

If protrusion 52 and receptacle 54 has non circular shapes, the non-circular shapes may help to prevent rotation of the trunk members relative to each other. For example, FIGS. 1 and 4A-7, show roughly square cross sectional shapes of protrusion 52 and receptacle 54. The mated square shapes prevent rotation while the trunk members are connected. However, with a square shape, the user may combine the trunk members (e.g., combine trunk member 30 and trunk member 40, or combine trunk member 30 and curved trunk member 46) in four different positions with respect to each other, each position rotated approximately 90° with respect to an adjacent position. FIGS. 26-28 illustrate this principle and show a curved trunk member 46 rotated at different angles with respect to the trunk member 30. Although the trunk members are coupled/attached to each other in a different way in FIGS. 26-28, the trunk members shown in FIGS. 1-7 may be similarly rotated and locked into different positions with respect to each other, each position offset by approximately 90° from an adjacent position. In each of the four positions, the square shapes of the protrusion 52 and receptacle 54 prevent rotation of the trunk members relative to each other while they are connected. If shapes with more sides than a square are used, more angles and positions are possible (e.g., a pentagonal shape would have 5 positions, a hexagonal shape would have 6 positions, and so on). If a triangular shape is used, three positions and angles are possible. If a rectangular shape is used, two positions 180° apart are possible. Selective rotation of the trunk member 40 and/or the curved trunk member 46 relative to the trunk member 30 in variations discussed above may alternately position branch member 70, branch member 76, and/or the second trunk end 24 of curved trunk member 46 in a plane substantially parallel to that of branch members 50 and 60 or in a plane that is not parallel (e.g., a substantially perpendicular plane) to that of branch members 50 and 60.

FIGS. 23-28 show an exemplary therapeutic device/system 10 similar to the therapeutic device/system 10 of FIGS. 1-7. Similar reference numbers as those used in FIGS. 1-7 have been used in FIGS. 23-28 for similar components, features, elements, etc. Features of the embodiments shown in FIGS. 1-7 may be used in embodiments shown in FIGS. 23-28, and vice versa, unless expressly stated otherwise. FIGS. 23-28 show another possible method of attachment between trunk members. In FIGS. 23-28, a trunk member 40 is removably engaged with a trunk member 30 along a trunk joint 26. Optionally, the trunk joint 26 may be substantially midway between the first trunk end 22 and the second trunk end 24. A first engagement hole 42 is formed in the trunk member 40 and/or curved trunk member 46 (e.g., in receptacle portion 54), and a corresponding spring-biased pin 32 is installed on the trunk member 30 (e.g., on protrusion 52) and configured for removable engagement with the first engagement hole 42. Other engagement holes may also be provided in the trunk member 40 and/or curved trunk member 46 such that the trunk members may be rotated and locked into a variety of different positions with respect to each other. For example, a second engagement hole 44 may be formed in the trunk member 40 and/or curved trunk member 46 approximately ninety degrees from the first engagement hole 42, whereby the trunk member 40 and/or curved trunk member 46 may be selectively rotated by approximately ninety degrees relative to the trunk member 30 and be removably engaged and/or releasably locked therewith through the engagement of the spring-biased pin 32 with the second engagement hole 44. Other positions are possible with more engagement holes, including forming relative positions between trunk members similar to those discussed above (e.g., with respect to FIGS. 1-7).

Because the trunk members may be rotated to multiple landing stations/positions, a user may adjust the therapeutic device 10 to allow for more comfort and leverage to massage all areas of the body for any and all body shapes and sizes. For example, curved trunk member 46 may be rotated to a desired position and used to massage a user's own back. In one embodiment, second end 24 points in the same direction as the first end 22 and may be hooked around a users side and/or back to massage even hard to reach areas of the body.

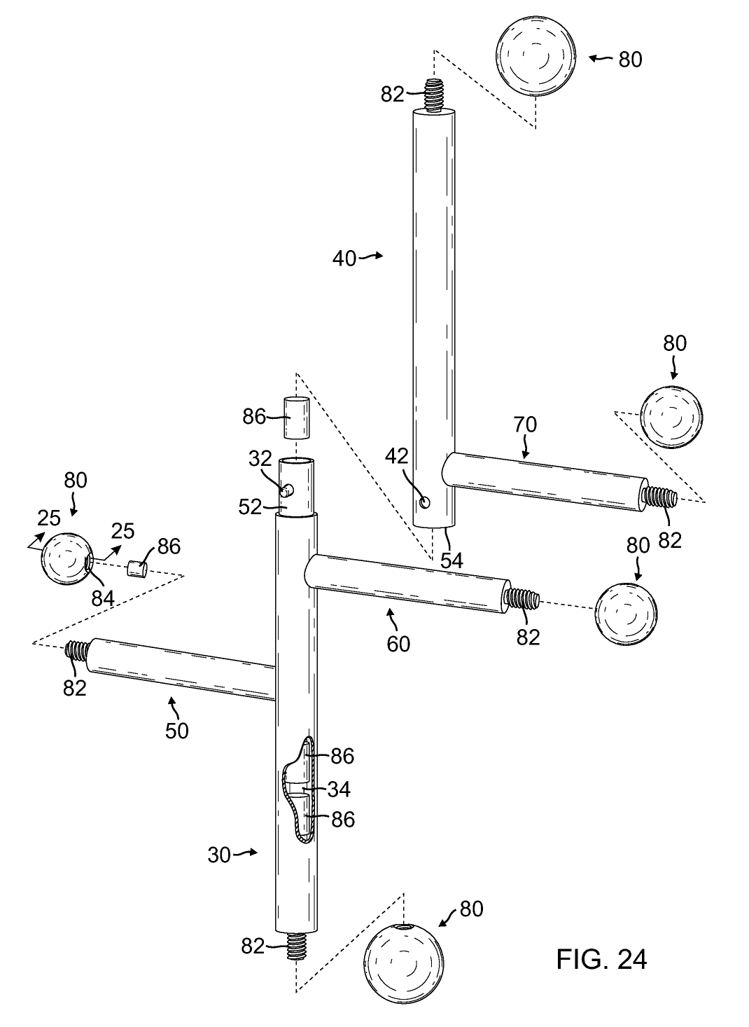

Each trunk member of the therapeutic device may include one or more branch members (e.g., branch members 50, 60, 70, 76), but a branch member is not required (e.g., curved branch number 46 shown in FIGS. 1 and 6 includes branch member 76, but curved branch member 46 of FIGS. 24-26 does not include any branch member). The branch members may be connected to and/or extend from the trunk 20 between the first trunk end 22 and the second trunk end 24. The branch members (e.g., branch members 50, 60, 70, 76) may be a variety of sizes and shapes (e.g., straight, curved, etc.). In one embodiment, the branch members (e.g., branch members 50, 60, 70, 76) may have a length (extending from the main trunk portion of the trunk members) in the range from about 2 inches to about 10 inches, from about 3 inches to about 7 inches (e.g., a length of about 4 inches, about 4.3 inches, about 4.7 inches, or about 5 inches). Each of the branch members may have the same width or diameter or varied widths or diameters as compared to each other. The branch members may have the same width or diameter or varied widths or diameters as compared to the trunk members. In one embodiment, each of the branch members has a generally circular cross section sized between about 0.25 inches to about 2 inches, or from about 0.75 inches to about 1.5 inches (e.g., about 1 inch). (The term “about” as used here encompasses variations within +0.2.)

One or more ends of the trunk members and one or more ends of the branch members may include one or more attachment/coupling mechanisms or regions for removably coupling/attaching a therapy object 80. For example, the branch members may include threaded portions 81 that threadably engage with a threaded portion 83 in a bore 84 of a therapy object. Optionally, the therapy object 80 may attach to end of the branch members or trunk members via friction fit, clamping, adhesion, a mated protrusion and receptacle, locking pin, telescoping attachment, and other attachments. In one embodiment, one or more posts 82 may be formed on one or more of the trunk members and/or one or more of the branch members. One or more corresponding bores 84 may be formed in a therapy object 80 and may be configured to engage and attach to the post 82, whereby the therapy object 80 may be removably installed on one or more of the trunk members and/or one or more of the branch members. Optionally, the post(s) 82 and bore(s) 84 may include threaded portions or regions (e.g., threaded portion 81 and threaded portion 83) that threadably engage each other. For example, the post 82 may be formed with male threads (e.g., as shown on threaded portion 81) and the bore 84 may be formed with corresponding female threads (e.g., as shown on threaded portion 83), whereby the therapy object 80 may be threadably installed on one or more of the trunk members and one or more of the branch members.

Branch members (e.g., branch members 50, 60, 70, 76) may act as extenders to which one or more therapy objects 80 may be attached for various types of treatment and/or massage. For example, as shown in FIG. 2, mid-sized balls 104 may be attached to adjacent branch members 60 and 70; these may then be used for massage for which two relatively close balls are desired (e.g., the two mid-sized balls 104 may be slid, walked, or rotated along a person's back. As shown in FIG. 3, small-sized balls 102 may be attached to adjacent branch members 60 and 70; these may then be used for massage for which two balls spaced further apart are desired (e.g., if the two small-sized balls 102 are slid, walked, or rotated along a person's back, the massage will feel and work muscles differently than it would with the two mid-sized balls 104 of FIG. 2). Branch member (e.g., branch members 50, 60, 70, 76) may also act as handles a user may hold onto and manipulate when using the therapeutic device. For example, arranging the therapeutic device 10 with branch members extending in opposite directions (e.g., 180° apart) from the elongate trunk may make it easier to rotate or spin (e.g., a winding motion or an unwinding motion) the therapeutic device during massage or other treatment (e.g., rotating the therapeutic device around the longitudinal axis of a straight portion of elongate trunk 20 and/or rotating the device in a plane perpendicular to the longitudinal axis). Multiple branch members may be used as multiple handles, and may be arranged, rearranged, assembled, reassembled, etc. to offer a variety of hand held positions for comfort in applying self-massage or patient-massage and trigger point pressure into a body's core, internals, back, shoulders, legs, feet, arms, hands, neck, buttocks, hips, hip flexors, arm pits, etc.

In one embodiment, a first branch member 50 may be connected to and/or extend from the trunk member 30. A second branch member 60 may also be connected to and/or extend from the trunk member 30. Optionally, the second branch member 60 may extend substantially parallel to and in an opposite direction from the first branch member 50. A third branch member 70 may be connected to and/or extend from the trunk member 40. A fourth branch member 76 may be connected to and/or extend from the curved trunk member 46. In one embodiment, the trunk member 30 and the trunk member 40 may be connected/attached such that the second branch member 60 and the third branch member 70 extend substantially parallel to one another in a substantially common direction from locations on the respective trunk member 30 and trunk member 40 substantially equidistant from the trunk joint 26 and/or the connector nut 36. The first branch member 50 may extend substantially parallel to and in an opposite direction from the second branch member 60 and the third branch member 70 from a location on the trunk member 30 between the second branch member 60 and the first trunk end 22.

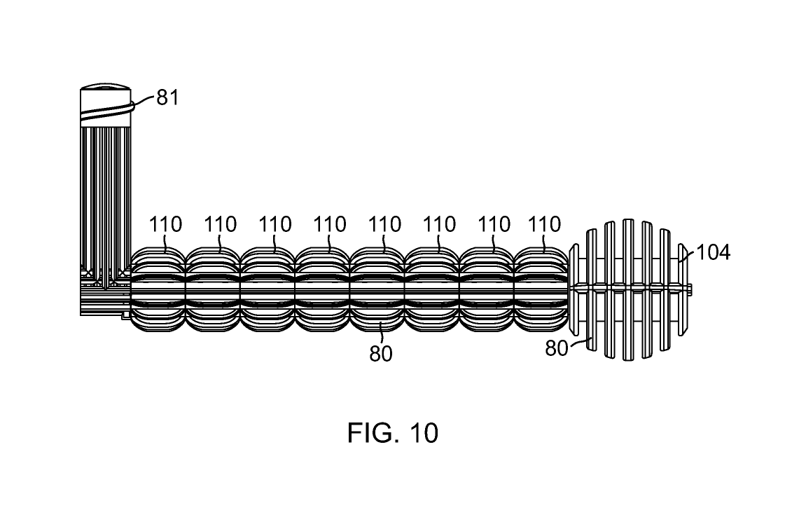

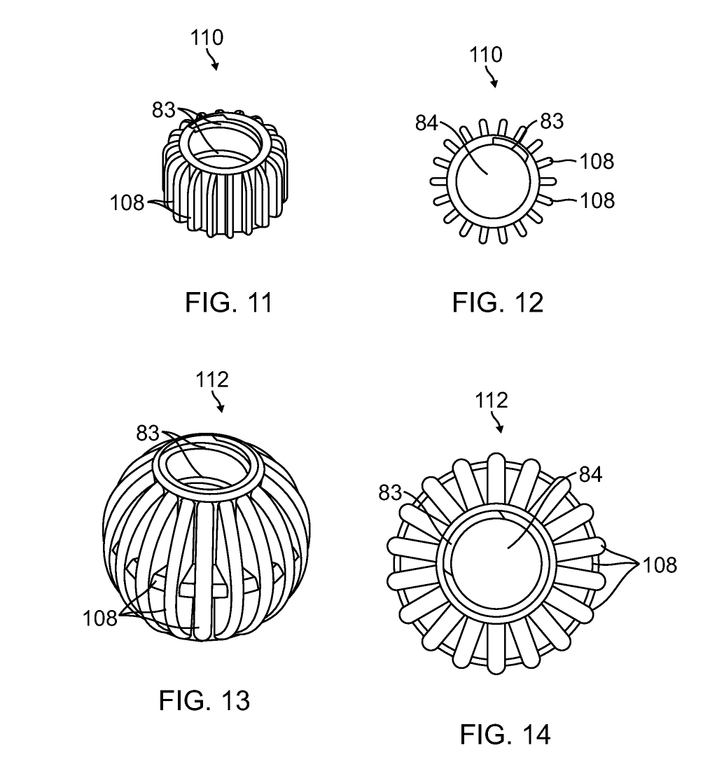

Therapeutic device/system 10 may include a variety of therapy objects 80. For example, FIG. 1 shows therapy objects 80 configured as a large ball 106 and a small ball 102, and each of balls 102 and 106 may be attached to any portion 81 on any of the trunk members and branch members. FIG. 2 shows therapy objects 80 configured as a small ball 102, mid-sized balls 104, spinners 110, and open-ended mid-sized balls 112. While the spinners 110 and open-ended mid-sized balls 112 are shown as being on a main trunk portion of the trunk member 30, these could optionally be arranged on a trunk portion of the trunk member 40. FIG. 3 shows therapy objects 80 configured as small balls 102, a large ball 106, spinners 110, and open-ended mid-sized balls 112. FIG. 9 shows therapy objects 80 configured as spinners 110 and open-ended mid-sized balls 112. FIG. 10 shows therapy objects 80 configured as spinners 110. FIGS. 11 and 12 show isometric and end views, respectively, of a therapy object configured as a spinner 110. FIGS. 13 and 14 show isometric and end views, respectively, of a therapy object configured as an open-ended mid-sized ball 112. FIG. 25 shows a cross sectional view of an exemplary therapy object configured as a ball, but with a smooth outer surface. Each of these therapy objects 80 may be attachable to one or more trunk members (e.g., trunk members 30, 40, and 46) and/or one or more branch members (e.g., branch members 50, 60, 70, 76), for example, as discussed above. The therapy objects 80 may be made of a variety of materials and may be pliable or rigid. In one embodiment, the therapy objects may be made of wood, metal, plastic, rubber, nylon, other materials, and/or a combination of these. In one embodiment, a portion or all of one or more therapy objects is transparent or translucent.

While small, mid-sized, and large balls are depicted in the figures, many other sizes are also possible. A variety of sizes of therapy objects 80 may be provided with the therapeutic device 10 to allow for a variety of configurations using a variety of combinations of sizes of therapy objects 80. In one embodiment, therapy objects 80 may range in size from 5 inches in diameter to 1 inch in diameter. In one embodiment, therapy objects 80 may range in size from 3.75 inches in diameter to 1.5 inches in diameter. Therapy objects 80 of various sizes may be included as components of the therapeutic device 10. In one embodiment, four therapy object ball sizes are provided with the therapeutic device 10, e.g., a small ball 102, medium or mid-size ball 104, a large ball 106, and an extra large ball (not shown). In one embodiment, small balls 102 range in size from about 2.5 inches in diameter to about 1 inch in diameter (e.g., about 1.5 inches or about 2 inches in diameter). In one embodiment, medium or mid-sized balls 104 range in size from about 3.5 inches in diameter to about 1.5 inches in diameter (e.g., about 1.8 inches, about 2.4 inches, or about 2.7 inches in diameter). In one embodiment, large balls 106 range in size from about 4 inches in diameter to about 2 inches in diameter (e.g., about 2.5 inches, about 2.8 inches, or about 3 inches in diameter). In one embodiment, therapy objects configured as extra large balls range in size from about 5 inches in diameter to about 2.5 inches in diameter (e.g., about 3.5 inches or about 4 inches in diameter). In one embodiment, one or more spinners 110 and one or more open-ended mid-size balls 112 may be included. In one embodiment, spinners 110 range in size from about 2.5 inches in diameter to about 1 inch in diameter (e.g., about 1.5 inches or about 2 inches in diameter). In one embodiment, open-ended mid-size balls 112 range in size from about 3.5 inches in diameter to about 1.5 inches in diameter (e.g., about 1.8 inches, about 2.4 inches, or about 2.7 inches in diameter). (The term “about” as used here encompasses variations within +0.2.)

Therapy objects 80 configured as attachable and detachable spinners 110 and/or open-ended mid-size balls 112 are shown in FIGS. 9-14. The attachable and detachable spinners 110 and/or open-ended mid-size balls 112 may be configured to slide onto a portion of the trunk 20 of the therapeutic device 10 and/or one of the trunk members (e.g., trunk members 30, 40, 46). The hole or bore 84 of the spinners 110 and/or open-ended mid-size balls 112 may be configured to slide over a portion of one or more of the trunk members. For example, FIGS. 2, 3, 9, and 10 show spinners 110 and/or open-ended mid-size balls 112 positioned over a portion of the trunk of the trunk member 30 (although spinners 110 and/or open-ended mid-size balls 112 may similarly be positioned over a portion of the trunk of trunk member 40). The spinners 110 and/or open-ended mid-size balls 112 may be arranged and rearranged in different ways; for example, FIGS. 9 and 10 depict two different arrangements that may be used on a portion of a trunk member. The spinners 110 and/or open-ended mid-size balls 112 may be configured to spin freely around the trunk member. Optionally, the spinners 110 and/or open-ended mid-size balls 112 may spin independently of one another or may include notches or other features that interlock with adjacent spinners 110 and/or open-ended mid-size balls 112 such that all the spinners 110 and/or open-ended mid-size balls 112 spin together. The spinners 110 and/or open-ended mid-size balls 112 positioned on the trunk member may be rolled along or down a portion of a body for treatment and/or massage. In one embodiment, a motor may be included on a portion of a trunk member that may cause the spinners 110 and/or open-ended mid-size balls 112 to spin at one or more rates (if the spinners 110 and/or open-ended mid-size balls 112 interlock, then they will spin together at the same rate). This may provide a more powerful massage and be used for various treatments. In one embodiment, eight spinners 110 and/or two or four open-ended mid-size balls 112 may be included or provided with therapeutic device 10. The spinners 110 and/or open-ended mid-size balls 112 may include an internal threaded region 83 or may have a smooth interior (e.g., inside hole or bore 84). In one embodiment, the spinners 110 and/or open-ended mid-size balls 112 may be threaded over threaded portion 81 and then slid along the trunk member into the desired position. While open-ended mid-size balls 112 are discussed, the disclosure is not limited to these and other types of open-ended balls of various sizes and/or shapes may be used.

Optionally, a rope, cord, band, etc. may be provided with and/or as part of the therapeutic system/device. The rope, cord, band, etc. may be stretchy, resilient, elastic, etc. One or more of the spinners 110 and/or open-ended balls may be threaded onto the rope, cord, and/or band and be used to pull the spinners and/or open ended balls toward a part of the body for massage and/or roll the spinners and/or open-ended balls along a portion of a patient's body.

In one embodiment, at least three branch members (e.g. branch member 50, 60, 70, and/or 76) are connected to and/or extend from the elongate trunk 20, and at least five therapy objects 80 are removably engaged with the device, two therapy objects 80 with the elongate trunk 20 at the first trunk end 22 and the second trunk end 24, and three therapy objects 80 respectively with the at least three branch members. One, some or all of the therapy objects 80 are may be configured as a ball.

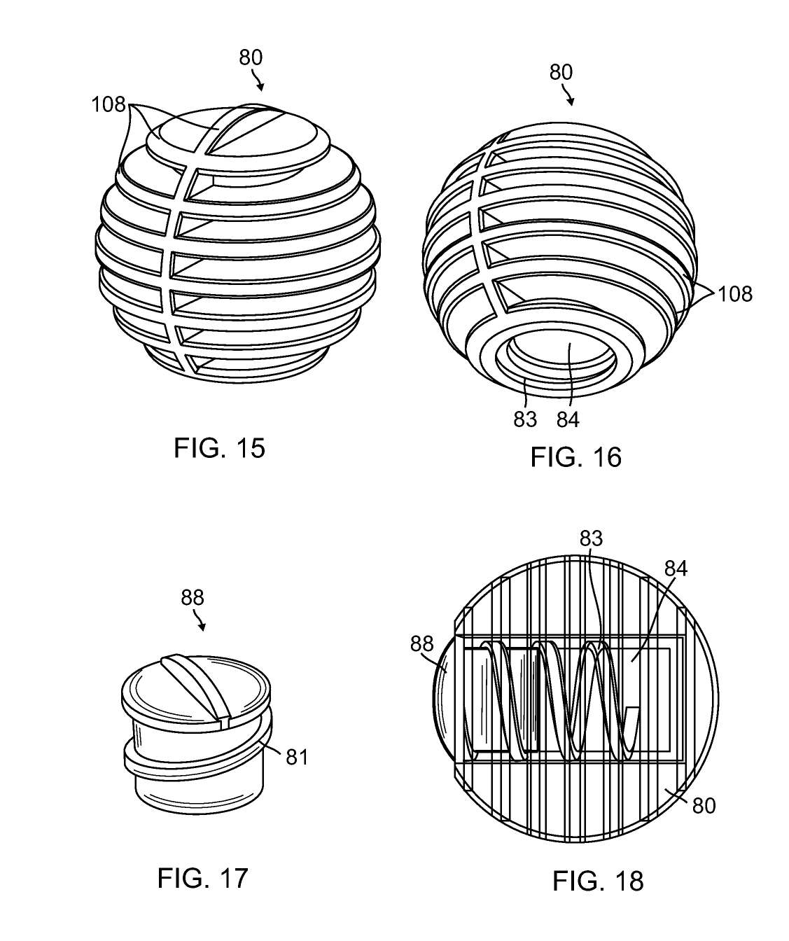

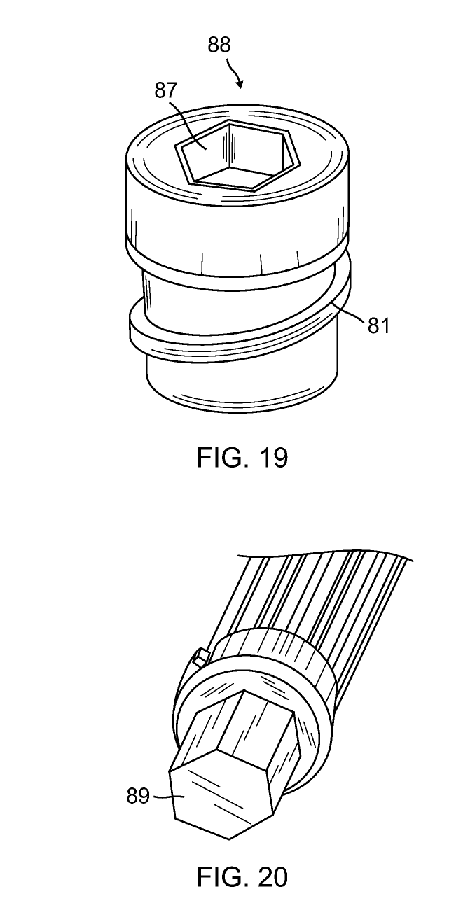

The therapy objects 80 discussed herein may include ridges 108 to facilitate some massage and therapy. For example, running ridges 108 over a portion of the body (e.g., a muscle) with the ridges parallel to the portion of the body may help lengthen the soft tissue in that portion of the body, whereas running ridges 108 over a portion of the body (e.g., a muscle) with the ridges perpendicular to the portion of the body may help break up blockages, scar tissue, soft cartilage, bunions, calcium build up or deposits, and/or inflammation pockets in that portion of the body. The ridges may be provided on the therapy objects 80 as horizontal (e.g., see majority of ridges in FIG. 15), vertical (e.g., see majority of ridges in FIG. 13), and/or oblique ridges. The ridges 108 may include deep and/or shallow valleys between the ridges 108, e.g., deep valleys are shown between ridges 108 in FIG. 20.

A hole or bore 84 may be formed in the therapy objects 80 discussed herein. The bore 84 may be threaded (e.g., with a female threaded portion 83) to threadably engage a threaded portion 81 on one or more trunk members and/or one or more branch members of the trunk members. The hole or bore 84 may also be configured to removably receive one or more therapy enhancement elements 86. Further, one or more therapy enhancement elements 86 may be configured to be removably received within the hole or bore 84. The therapy enhancement elements 86 may include one or more of the following: a heating element, a vibrational element, an electrical element, a micro-current element, a laser therapy element, and an LED light therapy element. The trunk members of the therapeutic device 10 may have a bore 34 formed therein and may be hollow or partially hollow as discussed above. The therapy enhancement elements 86 may be selectively and removably stored and/or used within the bore 34 or within a hollow region of the trunk members (e.g., inside trunk member 30, trunk member 40, and/or curved trunk member 46). For example, FIG. 24 shows an exploded view of an exemplary therapeutic device with therapy enhancement elements 86 stored within a hollow portion of a trunk member. The therapy enhancement elements 86 may be used to enhance the treatment and/or massage provided by the therapeutic device 10. The therapy enhancement elements 86 may be activated and then placed inside of one or more of the therapy objects 80 and/or the one or more of the trunk members. If activated during the massage and/or treatment with the therapeutic device 10, then additional benefits may be had. For example, if a heating element is used inside of a therapy object 80, then the therapy object 80 may heat up and help loosen muscles and/or treat painful areas. If a vibration element is used inside of a therapy object 80, then the therapy object may vibrate and help loosen muscles, break blockages, etc. Various additional benefits may come from the different types of therapy enhancement elements 86 used. Bore 84 of the therapy objects 80 may be sized to accommodate one or more therapy enhancement elements 86 and still attach to a trunk member and/or a branch member of a trunk member, e.g., so the therapy enhancement element may be actively used inside a therapy object while the therapy object is attached to one or more other portions of the therapeutic device 10 (see e.g., FIG. 24).

With all the combinations and/or configurations possible for therapeutic device 10, a user may assemble the therapeutic device or components thereof in a variety of ways for different purposes, treatments, and/or massages. One may also turn the device in any direction and arrange handles or branch members in various ways to find what is most comfortable in order to give the user and/or patient the best deep therapeutic trigger point massage possible. A user may use any size(s) of therapy objects 80 that is most comfortable and/or most effective for the user, patient, treatment, and/or massage. When applying pressure, a smaller therapy object 80 or ball corresponds to a more specific and/or narrow area that will be targeted and more focused pressure during treatment and/or massage, and larger therapy objects 80 or balls correspond to progressively broader areas that will be targeted and cause a progressively broader spread/coverage of pressure during treatment and/or massage. The individual components, including the elongate trunk 20, may be broken down to individual components to make travel with the therapeutic device 10 easier. A travel case and/or travel bag may be provided with the therapeutic device 10 to hold the various components and make travel even easier. The travel case and/or travel bag may be self-closing or be biased to a closed position.

One or more plugs or caps 88 may be provided. The one or more plugs or caps 88 may be selectively positionable within an opening or bore 84 of one or more therapy objects 80, and/or may be configured to close the opening or bore 84 in the therapy objects 80. FIGS. 17 and 19 show exemplary caps 88 that may be used. In one embodiment, the caps 88 may be used to complete the sphere of the therapy objects 80 (e.g., of therapy objects 80 configured as balls) and form closed balls, such closed balls may be used individually or together, e.g., for treatment and/or massage. Plug or caps 88 may attach to therapy objects 80 in one or more ways similar to the ways the trunk members and/or branch members of the trunk members attach to the therapy objects 80 (see discussion above). In one embodiment, plug or cap 88 may include a male threaded portion 81 (e.g., as shown in FIG. 17) that mates with and threadably engages a female threaded portion 83 of the therapy objects 80.

The cap 88 shown in FIG. 19 differs from the cap 88 in FIG. 17 in that the cap in FIG. 19 does not include a ridge along its top and has a female Allen wrench receptacle 87 on its top. The female Allen wrench receptacle 87 may mate with an Allen wrench or a male Allen wrench shaped protrusion 89 on a portion of one or more of the other components of the therapeutic device (see e.g., FIG. 20). By positioning a corresponding Allen wrench or male Allen wrench shaped protrusion 89 in the female Allen wrench receptacle, the cap 88 of FIG. 19 may be screwed into or out of a therapy object to open or close off the therapy object. While an Allen wrench receptacle 87 is shown in FIG. 19 and a male Allen wrench shaped protrusion 89 is shown in FIG. 20 as exemplary mating portions, other mating portions may be used, e.g., a Phillips-head receptacle and protrusion, a flat-head receptacle and protrusion, a Torx-shaped receptacle and protrusion, etc. FIG. 20 shows an exemplary male Allen wrench shaped protrusion 89 extending out from a surface of an end of a trunk member or branch member. The Allen wrench shaped protrusion 89 may be formed on any of the ends of the trunk members and/or branch members described herein. Further, a male Allen wrench shaped protrusion may be formed on one or more ends of a connector 120.

FIG. 18 shows a transparent of a therapy object (e.g., mid-sized ball 104) with a plug or cap 88 threadably engaged inside the therapy object to close the therapy object 80. The therapy object is shown as transparent in FIG. 18 so that the plug or cap 88 is visible inside the therapy object. If threaded (e.g., include a male threaded portion 81), the caps 88 may twist into the therapy objects 80 to threadably engage them (e.g., to form closed spheres). A plug or cap 88 may close off the bore 84 of a therapy object 80, e.g., as shown in FIG. 18, such that the therapy object 80 may be used as an individual treatment tool (e.g., used as a treatment ball, not attached to the trunk members).

Optionally, plug or cap 88 may be used to retain one or more therapy enhancement elements 86 inside one or more therapy objects 80. If one or more therapy enhancement elements 86 were inside the therapy object 80, the one or more therapy enhancement elements 86 would be securely retained inside the therapy object 80 by plug or cap 88. Plug or cap 88 may include a bore or hollow portion that allows a therapy enhancement element 86 to fit at least partially therein, e.g., to help accommodate one or more therapy enhancement elements 86 in smaller therapy objects like small ball 102 or mid-sized balls 104, in which bore 84 may be small.

Optionally one, some, or all the therapy objects 80 may be configured as open-ended balls similar to open-ended mid-size ball 112 shown in FIGS. 13 and 14. The same sizes may be used as discussed above with respect to the therapy objects 80 configured as balls (e.g., small, medium, large, extra large). Bore 84 may extend all the way through the open-ended balls. Caps 86 may then be used to close off one or both of the ends of the open-ended balls. With only one end closed by a single cap 88, the open-ended ball and cap combination may resemble one or more of the small balls 102, medium or mid-size balls 104, and/or large balls 106, and may be used in the same way as these balls 102, 104, 106, and/or any of the therapy objects 80 configured as balls described above. With two caps 88 closing both ends of an open-ended ball, the ball may form a closed sphere or closed ball that may be used similar to the closed spheres or balls described above. Also, because the balls are open on both ends and have a bore 84 extending there through, then they may each be used similar to spinners 110 or open-ended mid-size balls 112 discussed above, e.g., they may be placed over a portion of the trunk as shown in FIGS. 9 and 10.

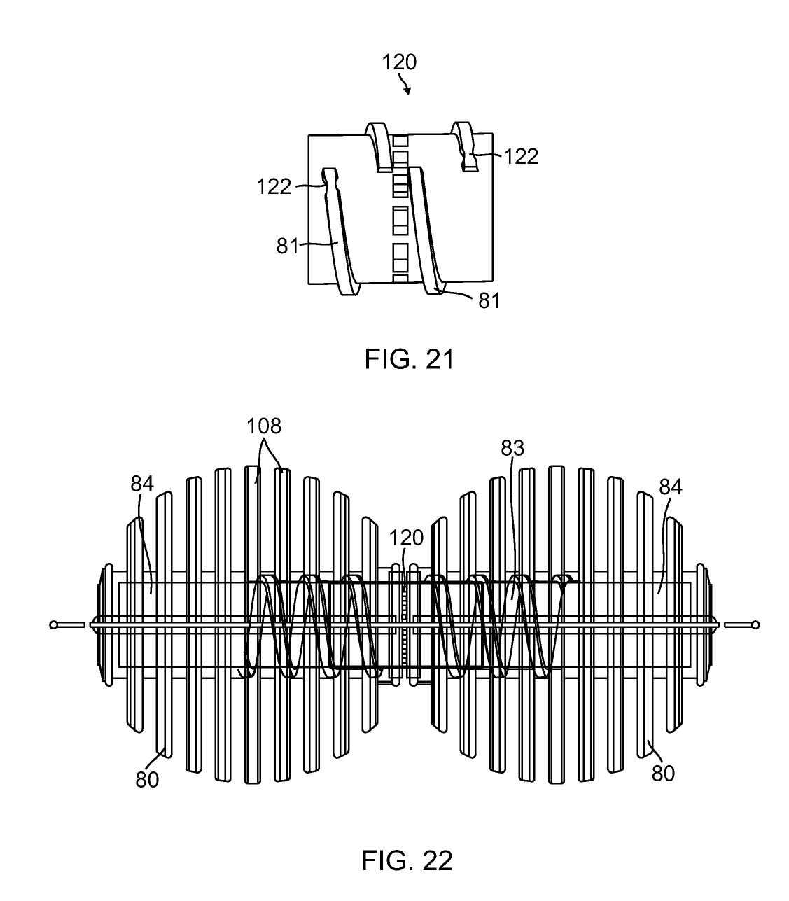

One or more connectors 120 (e.g., a short connector(s)) may be included or provided (e.g., in combination with therapeutic device 10 or as a separate therapeutic device with its own therapy objects) for connecting two or more therapy objects 80 together. In one embodiment, a double-sided connector 120 may connect two therapy objects 80 (e.g., two balls 102, 104, 106, and/or other sizes or shapes of balls, for example, an ovoid shaped ball, a spheroid shaped ball, etc.) together side by side. In one embodiment, a triple-sided connector 120 may connect three therapy objects 80 (e.g., two balls 102, 104, and/or 106) together in a roughly triangular or three-pronged shape. FIG. 21 shows an exemplary connector 120 configured as a double-sided connector (although triple-sided and/or quadruple-sided connectors, and so on are also possible). FIG. 22 shows a transparent view of two therapy objects 80 configured as balls connected to opposite sides of a connector 120. The therapy objects are shown as transparent in FIG. 22 so that the connector 120 is visible inside the therapy objects. In FIG. 22, the therapy objects 80 have very little space between them (e.g., less that the distance between two ridges 108 or less than 10% of the diameter of one of the therapy objects 80). In one embodiment, some or all of the therapy objects 80 configured as balls can twist together to be side by side using a double-sided connector. Connectors 120 may be shaped, sized, and/or otherwise configured to connect therapy objects 80 such that the therapy objects 80 have little space (e.g. less than 50% of the diameter of one of the connected therapy objects) and/or very little space (e.g., less than 10% of the diameter of one of the therapy objects) to no space (e.g., such that the therapy objects are touching or abutting) between them. These configurations using a connector to connect therapy objects relatively close together can be very beneficial for a variety of massages and therapies, and provides a cheaper, more compact, and easier to hold and travel with therapeutic device/sub-device than a therapeutic device with an elongate trunk or trunk members.

The connector 120 may be used to form one or more therapeutic devices or sub-devices (e.g., a two ball device as shown in FIG. 22) that may be used to treat and/or massage parts of a body. The one or more therapeutic device or sub-devices (e.g., the two ball device shown in FIG. 22) using a connector may be rolled along, slid, walked along, twisted, rotated, and/or otherwise moved along various parts of the body while applying pressure to treat and/or massage the body.

The one or more connectors 120 may have a variety of sizes and shapes (e.g., the one or more connectors 120 may have a diameter within the ranges disclosed for the trunk members above). In one embodiment, the one or more connectors 120 may have the same diameter or a slightly smaller diameter than the trunk members, but may correspond to the size of a bore in one or more therapy objects. The one or more connectors 120 may have a size similar to the connection ends of the trunk members and/or branch members, so the same therapy objects may be used on the ends and with the one or more connectors 120. The one or more connectors 120 may attach to therapy objects 80 in one or more ways similar to the ways the trunk members, branch members of the trunk members, and/or caps 88 attach to the therapy objects 80 (see discussions above). In one embodiment, connectors 120 may include one or more threaded portions (e.g., male threaded portions 81) that mate with and/or threadably engage a complimentary threaded portion on the inside of one or more therapy objects 80 (e.g., a female threaded portion 83). A threaded engagement or attachment is shown, for example, in FIG. 22. A Bore 84 in one or more of the therapy objects 80 may still be provided with one or more therapy enhancement elements 86 prior to connecting the therapy objects to the connector 120. The therapy enhancement elements 86 as used in conjunction with connector 120 and one or more therapy objects 80 attached thereto may function in similar ways to those described above with respect to therapy enhancement elements 86.

Connectors 120 may include one or more mechanisms or features to allow extension or contraction of the distance between therapy objects 80. In one position, the therapy objects 80 attached to a connector 120 may have very little space (e.g. less than 10% of the diameter of one of the connected therapy objects) to no space (e.g., such that the therapy objects are touching or abutting) between them, and in another position they may have more space between them (e.g., 20-100% of the diameter of one of the therapy objects). In one embodiment, connectors 120 may include one or more notches 122 positioned at locations along the threaded portion 81 that may help hold or lock the therapy objects 80 and different points along the threaded portion 81, which provides for more or less distance between the therapy objects 80. The notches 122 may mate with or interact with protrusions on the female threaded portion to help hold or temporarily lock the therapy objects at certain distances. Optionally notches may be formed on the female threading and protrusion on the male threading.

In one embodiment, connector 120 may include a telescoping central region and/or portions/sides that slide relative to one another (e.g., one having a portion sliding within the other). The connector 120 may include a locking mechanism, a pin, a spring-biased pin, latch, or similar mechanism that can lock the connector pieces/sides at different distances to extend or contract the length of the connector 120 and thereby the distance between therapy objects 80 attached to the connector 120. In one embodiment, the connector 102 may include a threaded portion that extends a further distance than that shown in FIG. 21 (e.g., completing several more rotations of the thread), such that the sides of the connector 120 may be threaded deep into the therapy objects 80 or more shallowly into the therapy objects 80 to adjust the distance between the therapy objects 80. One or more spacers may be provided that slide over the connector and cover a central region of the connector 120 to prevent threading the therapy objects 80 more deeply than desired.

Optionally the one or more connectors 120 or similar connectors may be used to connect two or more trunk members together. For example, one or more trunk members (e.g., trunk members similar to trunk members 30, 40, and 46 discussed above) may include one or more ends with a bore (e.g., similar to bore 84) with a female threaded portion (e.g., similar to the female threaded portion 83). In one embodiment, the protrusion 52 and/or receptacle 54 may be replaced with a bore similar to bore 84 with a female threaded portion (although, if a different type of connector 120 is provided, the end(s) of the trunk member may be configured to attach to the connector 120). A connector 120 may be threaded into one bore of a first trunk member, and a second trunk member may be threaded onto the other end of the connector 120 to combine the first trunk member and second trunk member together to form a combined elongated trunk. For example, a first trunk member 40 may be connected to a second trunk member 40, or in other combinations using a connector 120. In one embodiment more than one end of a trunk member may include a bore to mate with a connector 120 and/or one or more ends of a branch member of a trunk member may include a bore to mate with a connector 120. In any of the ends of the trunk members and/or branch members formed with a bore for connection to a connector 120, a connector 120 may be connected into the bore (e.g., by threading) and another trunk member, branch member, or therapy object with a bore may be connected to another end of the connector 120. For example, the device may be configured with two trunk members connected together using a connector, and other connectors 120 may be connected to other trunk member and/or branch member ends, each for connection to a therapy object 80. In this way, one or more connectors may be used at the various ends of the trunk members and/or branch members for connection to one or more therapy objects 80 and/or one or more other trunk members. Using one or more connectors in this way allows even more versatility and configurability to the therapeutic device to configure and reconfigure the device for various uses.

In one embodiment, a therapeutic device/system 10 may be used for personal massage and comprises an elongate trunk 20 having a first trunk end 22 and an opposite second trunk end 24, the elongate trunk 20 further comprising a first trunk member 30 and a second trunk member (e.g., trunk member 40 or curved trunk member 46) removably engaged with the first trunk member 30 (e.g., along a trunk joint 26 and/or using a connector nut 36). A first branch member 50 may be connected to and/or extending from the first trunk member 30. A second branch member 60 may be connected to and/or extending from the first trunk member 30. The second branch member 60 may extend substantially parallel to and in an opposite direction from the first branch member 50. Therapy objects 80 (e.g., there may be as many as 1, 2, 3, 4, 5, 6, 7, 8, 9, and/or 10 therapy objects 80) removably attachable/engageable with trunk members and/or branch members of the therapeutic device. A first therapy object 80 on the first trunk member 30 may be substantially at the first trunk end 22. A second therapy object 80 on the trunk member 40 or on the curved trunk member 46 may be substantially at the second trunk end 24. A third therapy object 80 may be on the first branch member 50. A fourth therapy object 80 may be on the second branch member 60. A fifth therapy object 80 may be on the third branch member 70 or on the fourth branch member 76. A sixth therapy object 80 may be on a fourth branch member. A seventh therapy object 80 may be on a fifth branch member, and so on.

In one embodiment, a therapeutic device/system 10 for personal massage comprises an elongate trunk 20 having a first trunk end 22 and an opposite second trunk end 24, the elongate trunk 20 may further comprise a first trunk member 30 and a second trunk member (e.g., trunk member 40 or curved trunk member 46) removably engaged with the first trunk member 30 (e.g., along a trunk joint 26 and/or using a connector nut 36). A first engagement hole 42 may be formed in the second trunk member substantially adjacent the trunk joint 26. A second engagement hole 44 may be formed in the second trunk member approximately ninety degrees from the first engagement hole 42. A corresponding spring-biased pin 32 may be installed on the first trunk member 30 and configured for selective removable engagement and/or releasable locking with the first engagement hole 42 and/or the second engagement hole 44, whereby the second trunk member may be selectively rotated by approximately ninety degrees relative to the first trunk member 30 and be removably engaged therewith through engagement of the spring-biased pin 32 with the first engagement hole 42 or the second engagement hole 44. The second trunk member may be a curved trunk member (e.g., curved trunk member 46) that is curved such that the second trunk end 24 extends in substantially the same direction as the first trunk end 22.

The components of the therapeutic device/system 10 described herein may be manufactured in a variety of ways, including using a mold or cast, injection molding, 3D printing, welding, carving, other methods, and/or a combination of these. All materials used to make the therapeutic device 10 and/or the components discussed above may be “green” friendly, e.g., recycled materials.

The components of the therapeutic device/system 10 described herein may be used in a variety of methods. The components of the therapeutic device 10 may be used for treatment and/or massage of a user's body and/or a patient's body. Methods of using the therapeutic device or any of its components may include any of the steps discussed herein, including steps of assembling the therapeutic device or components in a desired way to form a configured device (e.g., including any of the steps required to assemble variations of the device or components as discussed or shown herein), applying pressure with the configured device to a region of the body (e.g., a body's core, internals, back, shoulders, legs, feet, arms, hands, neck, buttocks, hips, hip flexors, arm pits etc.), moving the configured device along a region of the body (e.g., using a sliding, massage, spinning, rotating, walking, winding, unwinding, twisting, rubbing, digging, other movements described herein, other movements generally, and/or a combination of these movements). Users may be able to use the therapeutic device to work out the kinks of body pain from exercise, sports, injury, surgery, pregnancy, arthritis, tension in the jaw line and face, stress and emotions.

The above devices, components, systems, assemblies, methods, etc. have generally been described as being applied to a therapeutic device for personal massage; however, the principles described may be applied to other types of devices, components, systems, assemblies, methods, etc. Further, the features described in one embodiment herein may generally be combined with features described in other embodiments herein. All of the devices, components, systems, assemblies, methods, etc. disclosed and claimed herein may be made and executed without undue experimentation in light of the present disclosure.

While the devices, components, systems, assemblies, methods, etc. of this invention may have been described in terms of particular variations and illustrative figures, it will be apparent to those skilled in the art that the invention is not so limited and that variations may be applied to the devices, components, systems, assemblies, methods, etc. For example, with respect to the methods, uses, and/or steps described herein variations may occur in the steps, uses, the sequence/order of steps, etc. described herein without departing from the concept, spirit, and scope of the invention, as defined by the claims. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

What is claimed is:

1. A therapeutic massage device comprising:
a first trunk member including a first branch member extending perpendicularly from a main trunk portion of the first trunk member;
a second trunk member removably attachable to the first trunk member to form a combined elongate trunk having a first trunk end and an opposite second trunk end; and
one or more therapy objects removably attachable to the first trunk end, the second trunk end, and the first branch member.

2. The device of claim 1 wherein the second trunk member is curved such that the second trunk end extends in substantially the same direction as the first trunk end.

3. The device of claim 2 wherein the second trunk member is sized and shaped such that the user may hold the first trunk end in front of the user's body and have the second trunk end extend behind the user's body for use in massaging a back of the user's body.

4. The device of claim 1, wherein a protrusion is formed on an end of the first trunk member and a receptacle configured to mate with the protrusion is formed on an end of the second trunk member, and wherein the second trunk member is removably attachable to the first trunk member by inserting the protrusion into the receptacle.

5. The device of claim 4, further comprising a connector nut configured to hold the protrusion and the receptacle in a securely attached configuration, the connector nut including features to interact with locking extensions on or adjacent to the protrusion and the receptacle to hold the protrusion and the receptacle in the securely attached configuration.

6. The device of claim 4, wherein the protrusion includes a non-circular cross-sectional shape, and the receptacle includes a corresponding non-circular cross-sectional shape.

7. The device of claim 6, wherein the protrusion and the receptacle are configured such that the protrusion may be inserted into the receptacle in a first position and a second position, wherein the first trunk member is positioned at a first angle relative to the second trunk member when the protrusion is in the first position and the first trunk member is positioned at a second angle relative to the second trunk member when the protrusion is in the second position, the second angle being different from the first angle.

8. The device of claim 6, wherein the protrusion includes a four-sided cross-sectional shape, and the receptacle includes a corresponding four-sided cross-sectional shape.

9. The device of claim 8, wherein the protrusion and the receptacle are configured such that the protrusion may be inserted into the receptacle in a first position, a second position, a third position, and a fourth position, wherein the first trunk member is positioned at a first angle relative to the second trunk member when the protrusion is in the first position, the first trunk member is positioned at a second angle relative to the second trunk member when the protrusion is in the second position, the first trunk member is positioned at a third angle relative to the second trunk member when the protrusion is in the third position, and the first trunk member is positioned at a fourth angle relative to the second trunk member when the protrusion is in the fourth position, and wherein the second angle is offset 90° from the first angle, the third angle is offset 90° from the second angle, and the fourth angle is offset 90° from the third angle.

10. The device of claim 1, further comprising one or more spinners that may be arranged on a portion of the elongate trunk such that the one or more spinners may freely spin.

11. The device of claim 1, further comprising a cap designed to close one or more openings of the one or more therapy objects, and wherein when the cap closes an opening of a therapy object, the combination of the cap and the therapy object form a closed ball.

12. The device of claim 1, further comprising a connector configured to join a first therapy object and a second therapy object together to form a combined therapy object in which there is little or no space between the first therapy object and the second therapy object.

13. The device of claim 12, wherein the connector is configured such that the combined therapy object may be adjusted and locked into a first position in which the first therapy object and the second therapy object are separated by a first distance and into a second position in which the first therapy object and the second therapy object are separated by a second distance different from the first distance.

14. The device of claim 1, further comprising a connector, wherein a first bore configured to mate with a first end of the connector is formed at an end of the first trunk member and a second bore configured to mate with a second end of the connector is formed at an end of the second trunk member, and wherein the connector can be used to connect the second trunk member to the first trunk member to form the combined elongate trunk.

15. The device of claim 1 further comprising:
a bore formed in a first therapy object of the one or more therapy objects; and
a therapy enhancement element configured to be removably received within the bore.

16. A method of massage treatment comprising:
obtaining a configurable therapeutic device having a first trunk member, a second trunk member, and more than one therapy objects removably attachable to the first trunk member and the second trunk member;
assembling the configurable therapeutic device in a first configuration in which the first trunk member is attached to the second trunk member to form an elongate trunk, a first therapy object of the more than one therapy objects is attached to the first trunk member and a second therapy object of the more than one therapy objects is attached to the second trunk member;
applying pressure to a first region of a body with the configurable therapeutic device using at least one of the first therapy object and the second therapy object; and
moving the configurable therapeutic device in the first region of the body while continuing to apply pressure.

17. The method of claim 16 further comprising disassembling the configurable therapeutic device from the first configuration.

18. The method of claim 17 further comprising reassembling the configurable therapeutic device in a second configuration different from the first configuration.

19. A therapeutic massage device comprising:
a first therapy object including a first bore in a portion of the first therapy object;
a second therapy object including a second bore in a portion of the second therapy object;
a connector including a first connection end and a second connection end, wherein the first connection end is designed to mate with the first bore of the first therapy object and the second connection end is designed to mate with the second bore of the second therapy object such that the first therapy object and the second therapy object can be connected together using the connector to form a combined therapy object in which there is little or no space between the first therapy object and the second therapy object.

20. The device of claim 19, further comprising a third therapy object including a third bore and a fourth therapy object including a fourth bore, wherein the first connector end and the second connector end are designed to mate with each of the first bore, second bore, third bore, and fourth bore such that various combination of the first therapy object, the second therapy object, the third therapy object, and the fourth therapy object may be interchangeably connected to the first connector end and the second connector end to form various configurations of the combined therapy object.
